(19) United States
(12) Patent Application Publication
(10) Pub. No.: US 2014/0239828 A1
(43) Pub. Date: Aug. 28, 2014

(54) Dim to warm lighting module

(71) Applicant: Gregory S. Smith, Santa Ana, CA (US)

(72) Inventor: Gregory S. Smith, Santa Ana, CA (US)

(21) Appl. No.: 13/815,427

(22) Filed: Feb. 28, 2013

(51) Int. Cl. H05B 33/08

(52) U.S. Cl. CPC H05B 33/0845
USPC 315/187; 315/185 R

(57) ABSTRACT

The present invention is a lighting module, in particular, a lighting module that emits warmer color light as it dims. The lighting module preferably has a dimmable power source and a printed circuit board having at least two series of LEDs. The first LED series has a resistor and three LEDs that operate at full brightness at a first voltage, e.g. 12v. The second LED series has a voltage regulator, two capacitors and three LEDs that operate at full brightness at a second voltage, e.g. 6v, less than the first voltage. The first series has a different color light output from the second series. The module produces a linear color shift for a range of voltages, e.g. from seven volts to twelve volts.

### TECHNICAL FIELD

The present invention is a lighting module, in particular, a lighting module that emits warmer light as it dims.

### BACKGROUND ART

A typical voltage driven LED circuit has all of its LEDs dim as the voltage is reduced, e.g. from 12v to a point where the voltage is too low to power the LEDs and they do not emit light. In the typical voltage driven LED circuit, the LEDs all dim together at the same rate and the color remains approximately the same as the intensity diminishes. This differs significantly from incandescent lamps, which change color as the lamps are dimmed. The effect for dimming on incandescent lamps is to create a dimmer, but warmer, light with more red, yellow or golden color tones. This “dim to warm” effect or mood lighting is not available with typical voltage driven LED circuits.

### SUMMARY OF THE INVENTION

The present invention is a lighting module, in particular, a lighting module that emits warmer color light as it dims. The lighting module preferably has a dimmable power source and a printed circuit board having at least two series of LEDs. The first LED series has a resistor and three LEDs that operate at full brightness at a first voltage, e.g. 12v. The second LED series has a voltage regulator, two capacitors and three LEDs that operate at full brightness at a second voltage, e.g. 6v, less than the first voltage. The first series has a different color light output from the second series. The module produces a linear color shift for a range of voltages, e.g. from seven volts to twelve volts.

### BRIEF DESCRIPTION OF THE DRAWINGS

The objects and features of the present invention, which are believed to be novel, are set forth with particularity in the appended claims. The present invention, both as to its organization and manner of operation, together with further objects and advantages, may best be understood by reference to the following description, taken in connection with the accompanying drawings.

FIG. 1 is a top view diagram of a preferred embodiment of the invention;

FIG. 2 is a set of tables for light color outputs for the invention at various voltages with different LED series;

FIG. 3 is a circuit diagram of a preferred embodiment of the invention;

FIG. 4 is a side view of a preferred embodiment of the invention; and,

FIG. 5 is a partial circuit diagram of a preferred embodiment of the invention.

### DETAILED DESCRIPTION OF THE PREFERRED EMBODIMENTS

Various embodiments are now described with reference to the drawings, wherein like reference numerals are used to refer to like elements throughout. In the following description, for purposes of explanation, numerous specific details are set forth in order to provide a thorough understanding of one or more embodiments. It may be evident, however, that such embodiment(s) may be practiced without these specific details.

In the following paragraphs, the present invention will be described in detail by way of example with reference to the attached drawings. Throughout this description, the preferred embodiment and examples shown should be considered as exemplars, rather than as limitations on the present invention. As used herein, the “present invention” refers to any one of the embodiments of the invention described herein, and any equivalents. Furthermore, reference to various feature(s) of the “present invention” throughout this document does not mean that all claimed embodiments or methods must include the referenced feature(s). The following description is provided to enable any person skilled in the art to make and use the invention and sets forth the best modes contemplated by the inventor of carrying out his invention. Various modifications, however, will remain readily apparent to those skilled in the art, since the general principles of the present invention have been defined herein specifically to provide a “dim to warm” lighting module.

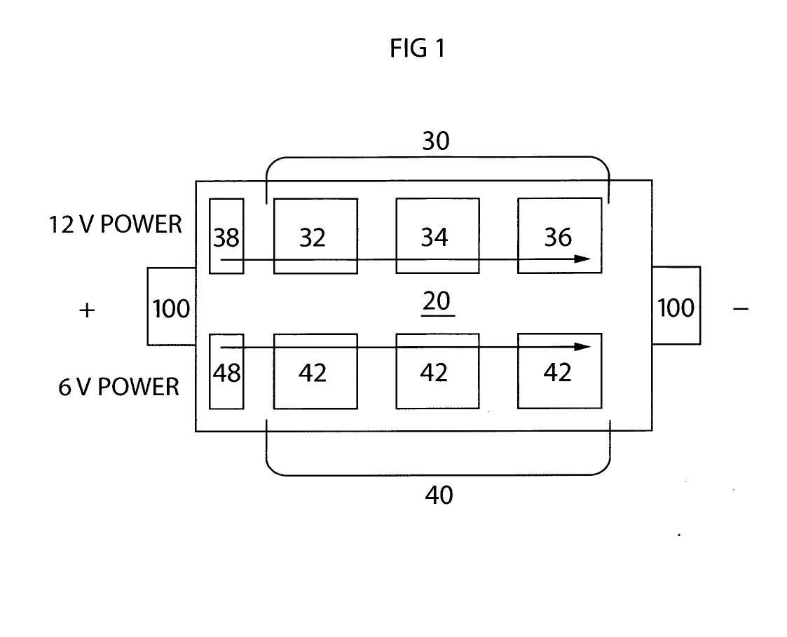

Referring now to FIG. 1, a top view diagram of a preferred embodiment of the invention 10 is shown. The preferred embodiment shown in FIG. 1 has a printed circuit board (PCB) 20 connected to a variable or dimmable twelve volt (12v) power source (not shown). The PCB 20 is preferably connected to the power source by metal end caps 100. A first LED series 30 is mounted on the PCB 20. The first LED series 30 of the preferred embodiment has a resistor 38 in series with a white 3.2v LED 32, a red 2.1v LED 34 and a white 3.2v LED 36. Preferably, a 101 ohm resistor 38 is used when three white or three warm white LEDs are used in the first LED series 30. When the first LED series 30 is two warm white LEDs and one yellow LED, the resistor 38 is preferably 121 ohms.

A second LED series 40 is mounted on the PCB 20 and in parallel with the first LED series 30. The second series 40 preferably has a 6v voltage regulator 48 (7806) in series with two capacitors 50 (330 nf and 110 nf) and a resistor 52 (12 ohms)(as shown in FIG. 5) and three 2.1v LEDs 42. Alternately, the voltage regulator 48 can be 5v (7805) or 8v (7808) depending on the combination of LEDs used in the second LED series 40. For example, red and yellow LEDs are lower forward voltage LEDs at 2.1vf. Thus, if three red or yellow LEDs are used in the second series 40 with a total vf of 6.3, then a 5v voltage regulator (7805) 48 is preferably used. Similarly, if the second series 40 utilizes two green or blue LEDs with a vf of 6.4, a 5v voltage regulator 48 again could be used.

Blue, green and white LEDs are generally higher forward voltage LEDs at 3.2vf. Accordingly, if two red or yellow LEDs are used in combination with a higher forward voltage LED, such as blue, green or white, for total forward voltage of 7.4vf, a 6v voltage regulator 48 would be preferable. If a combination of two higher forward voltage LEDs and one lower forward voltage LED are used with a total forward voltage of 8.5vf, an 8v voltage regulator 48 would be preferable. This variety of combinations allow a user to create a number of different “dim to warm” or “pastel to saturated color” combinations of light outputs from the module.

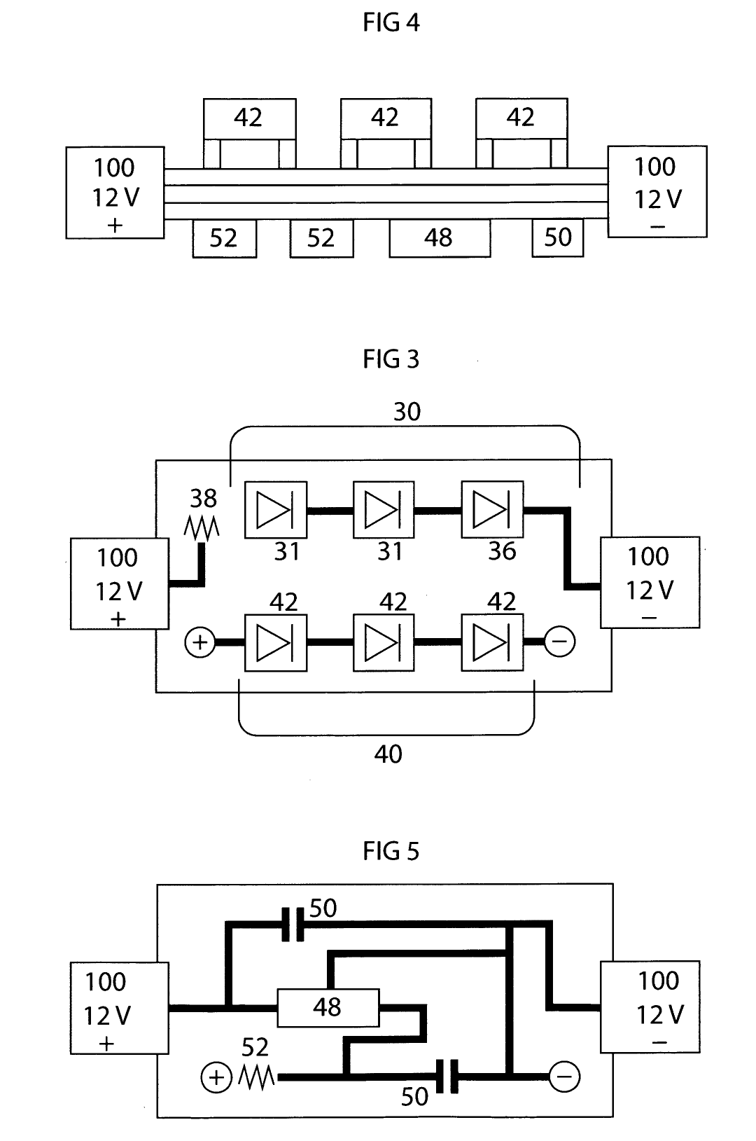

The first series of LEDs 30 preferably operate at full brightness (or intensity) at 12v and the second series of LEDs 40 operate at full brightness at 6v. As the voltage is reduced, e.g. to 10v, the intensity of the first LED series 30 is reduced and the intensity of the second LED series 40 remains the same and thus the color and/or light output of the second LED series 40 appears more pronounced. Thus, an overall color shift from the module occurs as the voltage is decreased. A circuit diagram of a preferred embodiment is shown in FIG. 3.

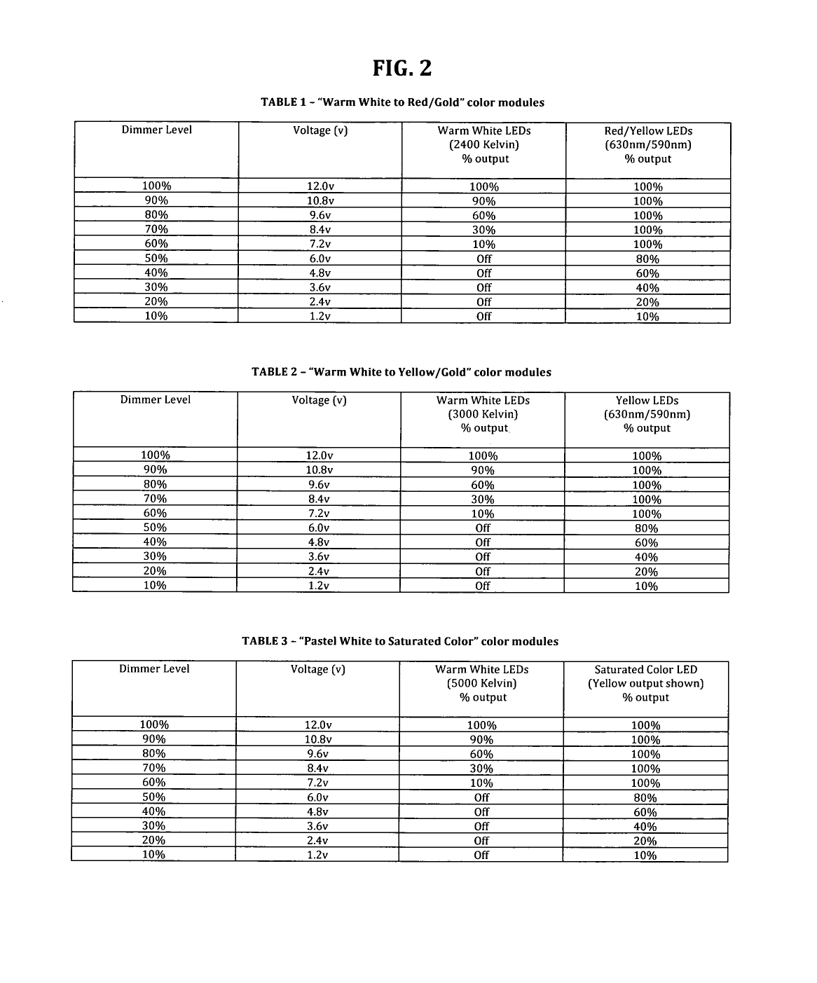

Turning now to FIG. 2, a set of tables is shown for various LED color combinations at different voltages. As shown, as the voltage is reduced from 12 volts (e.g. “one hundred percent voltage”) to 1.2 volts (e.g. “ten percent voltage”), the combination of illumination levels of the various LEDs is changed. For example, in table 1 of FIG. 2 at 7.2 volts (60% of full voltage), the warm white LEDs are only at 10% illumination while the red and yellow LEDs are at 100% illumination. There is thus a color shift (preferably linear) from warm white light to light with more red and yellow hues as the voltage dims. Alternately, other saturated colors such as blue, green, red, orange or purple can be used for color changes as the voltage dims.

Referring now to FIG. 4, a side view of a preferred embodiment of the invention is shown. Preferably, the LED series (40 shown) are mounted to the top of the PCB 20. The voltage regulator 48 and capacitors 40 for the second LED series and the resistor for the first series are mounted to the underside of the PCB 20. This provides for a more compact configuration.

Thus, a dim to warm lighting module is described above that produces “warmer” colored lighting with, e.g., red, yellow or gold tones as voltage is dimmed/reduced to the module 10. Alternately, another saturated color could be used as discussed in paragraph 4. In each of the above embodiments, the different positions and structures of the present invention are described separately in each of the embodiments. However, it is the full intention of the inventor of the present invention that the separate aspects of each embodiment described herein may be combined with the other embodiments described herein. Those skilled in the art will appreciate that adaptations and modifications of the just-described preferred embodiment can be configured without departing from the scope and spirit of the invention. Therefore, it is to be understood that, within the scope of the appended claims, the invention may be practiced other than as specifically described herein.

Various modifications and alterations of the invention will become apparent to those skilled in the art without departing from the spirit and scope of the invention, which is defined by the accompanying claims. It should be noted that steps recited in any method claims below do not necessarily need to be performed in the order that they are recited. Those of ordinary skill in the art will recognize variations in performing the steps from the order in which they are recited. In addition, the lack of mention or discussion of a feature, step, or component provides the basis for claims where the absent feature or component is excluded by way of a proviso or similar claim language.

While various embodiments of the present invention have been described above, it should be understood that they have been presented by way of example only, and not of limitation. Likewise, the various diagrams may depict an example architectural or other configuration for the invention, which is done to aid in understanding the features and functionality that may be included in the invention. The invention is not restricted to the illustrated example architectures or configurations, but the desired features may be implemented using a variety of alternative architectures and configurations. Indeed, it will be apparent to one of skill in the art how alternative functional, logical or physical partitioning and configurations may be implemented to implement the desired features of the present invention. Also, a multitude of different constituent module names other than those depicted herein may be applied to the various partitions. Additionally, with regard to flow diagrams, operational descriptions and method claims, the order in which the steps are presented herein shall not mandate that various embodiments be implemented to perform the recited functionality in the same order unless the context dictates otherwise.

Although the invention is described above in terms of various exemplary embodiments and implementations, it should be understood that the various features, aspects and functionality described in one or more of the individual embodiments are not limited in their applicability to the particular embodiment with which they are described, but instead may be applied, alone or in various combinations, to one or more of the other embodiments of the invention, whether or not such embodiments are described and whether or not such features are presented as being a part of a described embodiment. Thus the breadth and scope of the present invention should not be limited by any of the above-described exemplary embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future. Likewise, where this document refers to technologies that would be apparent or known to one of ordinary skill in the art, such technologies encompass those apparent or known to the skilled artisan now or at any time in the future.

A group of items linked with the conjunction “and” should not be read as requiring that each and every one of those items be present in the grouping, but rather should be read as “and/or” unless expressly stated otherwise. Similarly, a group of items linked with the conjunction “or” should not be read as requiring mutual exclusivity among that group, but rather should also be read as “and/or” unless expressly stated otherwise. Furthermore, although items, elements or components of the invention may be described or claimed in the singular, the plural is contemplated to be within the scope thereof unless limitation to the singular is explicitly stated.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, may be combined in a single package or separately maintained and may further be distributed across multiple locations.

As will become apparent to one of ordinary skill in the art after reading this document, the illustrated embodiments and their various alternatives may be implemented without confinement to the illustrated examples. For example, block diagrams and their accompanying description should not be construed as mandating a particular architecture or configuration. The previous description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. A lighting module comprising:
a variable voltage power source;
a plurality of LED series, where one of the plurality of LED series operates at full brightness when receiving a voltage less than another one of the plurality of LED series;
and where one of the plurality of LED series generates a different color light output from another one of the plurality of LED series.

2. The lighting module of claim 1 where one of the plurality of LED series has three LEDs, a voltage regulator and a plurality of capacitors.

3. The lighting module of claim 1 where the module has a linear color shift for a pre-selected range of voltages.

4. The lighting module of claim 3 where the pre-selected range of voltages is 7 volts to 12 volts.

5. The lighting module of claim 3 where the module outputs a linear color shift from 2400k warm white at one hundred percent voltage to 630 nanometer red and 590 nanometer yellow at ten percent voltage.

6. The lighting module of claim 3 where the module outputs a linear color shift from 3000k warm white at one hundred percent voltage to 590 nanometer yellow at ten percent voltage.

7. The lighting module of claim 3 where the module outputs a linear color shift from 5000k white at one hundred percent voltage to a single saturated color at ten percent voltage.

8. The lighting module of claim 7 where the saturated color is one from a group of colors of blue, green, red, orange or purple.

9. An LED module comprising:
a dimmable power source;
a printed circuit board having two series of LEDs;
where the first LED series has three LEDs that operate at full brightness at a first voltage;
where a second LED series has a voltage regulator and three LEDs that operate at full brightness at a second voltage less than the first voltage;
and where the first series has a different color light output from the second series.

10. The LED module of claim 9 where the module has a linear color shift for a pre-selected range of voltages.

11. The LED module of claim 9 where the range of voltages is seven volts to twelve volts.

12. The LED module of claim 9 where the first series of LEDs is a 3.2v white LED, a 2.1v red LED, and a 3.2v white LED, and the second LED series are three 2.1v yellow LEDs.

13. The LED module of claim 9 where the module outputs a linear color shift from 2400k warm white at one hundred percent voltage to 630 nanometer red and 590 nanometer yellow at ten percent voltage.

14. The LED module of claim 9 where the module outputs a linear color shift from 3000k warm white at one hundred percent voltage to 590 nanometer yellow at ten percent voltage.

15. The LED module of claim 9 where the module outputs a linear color shift from 5000k white at one hundred percent voltage to a single saturated color at ten percent voltage.
